(19) United States
(12) Patent Application Publication
(10) Pub. No.: US 2003/0225873 A1
(43) Pub. Date: Dec. 4, 2003

(54) Optimization of network performance through uni-directional encapsulation

(76) Inventor: Michael A. Wade, Chattanooga, TN (US)

Correspondence Address: DOUGLAS T. JOHNSON, MILLER & MARTIN, 1000 VOLUNTEER BUILDING, 832 GEORGIA AVENUE, CHATTANOOGA, TN, 37402-2289, US

(21) Appl. No.: 10/158,719

(22) Filed: May 30, 2002

(51) Int. Cl. G06F 15/173

(52) U.S. Cl. 709/223

(57) ABSTRACT

This application describes a system, including methods and apparatus, for identifying and utilizing an optimum network node for delivery of data. The system may transfer requests from one serving location to another, even across various unrelated autonomous systems. In response to a user request for data, the system will select the preferred node based on various costs metrics measuring network performance and health, such as available bandwidth, available servers, server load, network security, latency, jitter, packet loss, financial costs, and then transfer the request to the selected serving location, even across various unrelated, intermediate, autonomous systems. The user request is then served transparently from an optimal serving location. The system operates with established network communication protocols.

### FIELD OF THE INVENTION

This invention relates to the optimized distribution of data to clients connected to any IP-based network, including the Internet. In particular, the invention utilizes uni-directional encapsulation to forward a client's request for data to an optimal serving node hosting the requested data.

### BACKGROUND OF THE INVENTION

The Internet refers to a global network of connected computers throughout the world. The World Wide Web is the Internet's multi-media information retrieval system. In the World Wide Web environment, client machines communicate with web servers via application protocol, Hypertext Transfer Protocol (HTTP), to access the content of web pages. Web pages are typically presented in a language such as Hypertext Markup Language (HTML) to provide document formatting for the web pages. The web pages may display or provide “links” to files containing text, graphics, images, sound, video or other data. A web page location is specified on the Internet by a Uniform Resource Locator (URL) having a special syntax indicating the precise location of the file in the form “HTTP://internet.address/directory/filename.html”. An HTML-compatible browser such as Microsoft's Internet Explorer running on a client machines permits web pages to be graphically viewed and files to be requested via the URLs designated in the web language code describing the web page. These links designated by URLs may be to other web pages or to other file types such as “.pdf”, “.tiff”, “.jpeg”, and “.gif” graphics file; “.txt” and “.doc” text files; “.mp3” sound files; “.avi” or “.qt” video files; or “.ram” or “.asx” streuning media files.

The client's request for a particular web page or file is processed on the Internet as a series of “hops.” In general terms, each computer, router, or node on the Internet has a unique Internet address referred to as an Internet Protocol or IP address. When an intermediate computer or router receives the client message in transit, the computer checks the intended destination of the message and passes it along toward the server designated in the URL. The file requested by the client is then transmitted back across the Internet via another series of hops to the client computer. The efficient routing of client requests and served data files is implemented through a variety of protocols on routers. The complete Internet consists of a large number of interconnected autonomous systems (AS) each of which constitutes a distinct routing domain. Such autonomous systems are usually run by a single organization such as a company, branch of government or university. Within an AS, routers communicate with each other using an interior gateway protocol. The purpose of these interior gateway protocols is to enable routers to exchange locally obtained information so that routers within the AS remain aware of how to contact any server within the AS. The most efficient interior gateway protocols permit the routers to continually update the shortest internal path to each content hosting server within the AS. Interior gateway protocols are also utilized by companies providing Internet backbone communications to optimize the routing of the IP messages and data across their backbone networks.

The various autonomous systems comprising the Internet are connected via gateway routers and these routers exchange information using inter-domain routing protocols. The most frequently implemented inter-domain routing protocols are Border Gateway Protocol (BGP) or the older Exterior Gateway Protocol (EGP). BGP permits gateway routers to exchange network reachability information with other autonomous BGP systems, and in particular information about the list of autonomous systems that messages have passed through, called the autonomous system path or AS paths. This information can be used to construct a graph of AS connectivity to guide the “hops” of messages and data passing through the network autonomous systems.

Messages and data transmitted over the Internet are placed in data packets. The basic communication protocol through which different domains communicate is IP (Internet Protocol). Each Internet data communication is translated into the delivery of a sequence of varying sized IP protocol packets that travel across one or more administrative domains until they reach the final destination. The data packets have both an IP Header and a data field. The size of the data field is usually limited to about 512 bytes of data so that lengthy messages, image, sound, and multimedia files must be divided into multiple packets. For streamed [standard multimedia] files, it is necessary that most packets arrive in a timely fashion so that the play of the file is not interrupted. The IP Header contains a wealth of administrative information. This header information includes the version of IP protocol used, total packet and header lengths, source and destination addresses, the length of time the packet is allowed to travel the Internet before being discarded, the higher layer protocol that the packet should be handed off to (usually the layer 4 Transmission Control Protocol (TCP)).

TCP is utilized to create data segments for transmission in packets over the Internet and to reassemble packets received over the Internet. TCP accepts blocks of data, divides the data into segments, and attaches a TCP header to each segment. The TCP Header includes application information and a sequence number assigned to each segment created from a block of data before transmission. When the packet is received and handed off to TCP, the sequence numbers are checked to ensure that the data segments are reassembled in the correct order, and an acknowledgment is returned to the sender. The application information indicates the application program, such as File Transfer Protocol (FTP) or Simple Network Management Protocol (SNMP), that generated the data block, as well as the application program that should receive the data when it reaches its destination.

Over time, several factors have combined to cause the Internet to provide less than optimal data transfer. At the first of these factors is simply the Internet's enormous popularity and consequentially the heavy demand upon the Internet's resources. The second factor is a change in the types of content hosted on the World Wide Web. While early World Wide Web pages generally consisted of text and still images, the high speed connections now available to many users have lead to the frequent inclusion of audio and video clips, software programs, and even the live streaming of high quality audio and video content. The result, among other problems, is the familiar, frustrating user experience of protracted delay when attempting to access information through the World Wide Web, particularly during periods of heavy usage.

Many efforts have been made to improve the Internet's performance. One technique, implemented at an early stage of the Internet's development, was simply the mirroring of files or websites. Thus a software vendor might make download able files of its software available on servers in both the San Jose and New York and clients could pick the server in closest proximity to their location.

More advanced systems automatically select a relatively optimal mirrored site in response to a client request. These automatic systems may attempt to determine the geographic location of the client and direct the client's request to the mirrored server closest in proximity to the client; may use inter-domain protocol information to route the client's request to the server that appears to have the most desirable AS path to the client; may utilize load balancing information to direct the client's request to the mirrored server with the greatest amount of available resources; or a combination of such techniques. U.S. Pat. No. 6,108,703 to Leighton et al., and U.S. Pat. No. 6,185,598 to Farber et al., and U.S. Pat. No. 6,130,890 to Leinwand et al., U.S. Pat. No. 6,154,744 to Kenner et al., and U.S. Pat. No. 6,275,470 to Ricciulli, are examples of such attempts. In addition, other companies have attempted to bypass congestion on the Internet by utilizing satellite linkages to remote servers located at points of presence (POPs) as close as possible to the edge of the Internet and therefore close to clients. Satellite linked systems are capable of delivering a high quality connection to the POPs, however, every remote server in the network has to compete for limited downlink resources from the same satellite thus providing a relatively expensive solution per video stream carried over the network.

There remains a significant need to provide a content hosting and delivery solution that enables the efficient delivery of Internet content. The present invention provides a method of addressing these problems.

### A BRIEF SUMMARY OF THE INVENTION

It is the general object of the present invention to optimize the delivery of data to clients connected to any IP-based network, including the Internet.

Another object of the present invention is to utilize uni-directional encapsulation of client requests for data to minimize the communications overhead required to serve the requested data to the client from an optimal location.

The present invention accomplishes these and other objects by providing a means and apparatus for identifying and utilizing an optimum network node for delivery of data. The system may transfer requests from one serving location to another, even across various unrelated autonomous systems. In response to a user request for data, the system will select the preferred node based on various costs metrics measuring network performance and health, such as available bandwidth, available servers, server load, network security, latency, jitter, packet loss, financial costs, and then transfer the request to the selected serving location, even across various unrelated, intermediate, autonomous systems. The user request is then served transparently from an optimal serving location. The system operates with established network communication protocols.

### A BRIEF DESCRIPTION OF THE DRAWINGS

These and other objects of the invention may be explained with reference to the following drawings:

FIG. 1 is a simplified representation of the Internet with a simple client and server shown individually.

FIG. 2 is a simplified representation of an HTML document or web page with links or embedded objects.

FIG. 3 is a schematic illustration of an IP packet.

FIG. 4 is a schematic illustration of an encapsulated data packet.

FIG. 5 is a network topology diagram illustrating the requesting and serving of data according to the invention.

FIG. 6 is a schematic representation of Internet topology showing multiple serving nodes in connection with the Internet.

FIG. 7 is an illustration of the topology of a receiving node configuration according to the invention.

FIG. 8 is an alternative illustration of the topology of a receiving node configuration according to the invention.

FIG. 9 is a flow chart illustrating the processing of the packet once it arrives at a request node according to the invention.

### DETAILED DESCRIPTION OF THE INVENTION

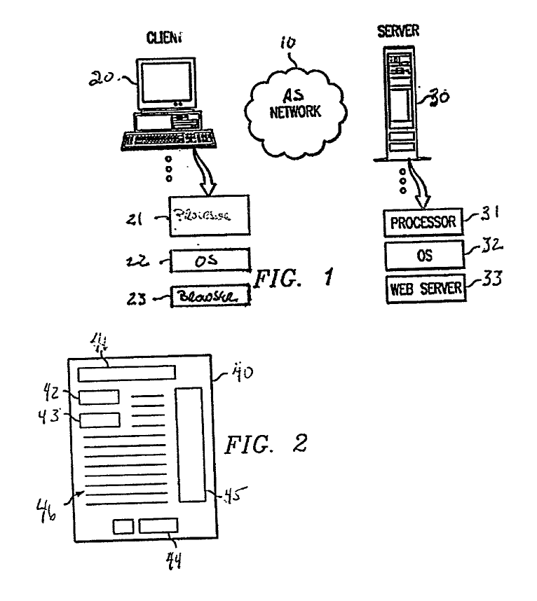

An Internet client server system is illustrated in simplified form in FIG. 1. Client machine 20 is connected to web server 30 via a network of autonomous systems 10 such as comprise the Internet. Web server 30 is one of many servers which are accessible by clients, such as client machine 20. The representative client machine 20 includes a processor 21 and is running an operating system 22 and a browser application 23, which is known software used to access servers on the Internet. The browser application 23 may in some instances be a part of the opening system 22, and the client machine 20 may be configured in many different fashions to communicate with the Internet. The server 30 also has at least one processor 31, on which runs operating system 32, and web server application software 33. The web server application software 33 supports files, typically in the form of hypertext documents or web pages and objects. The web server 30 may also be configured in many ways, and may be optimized as a cache for serving data.

FIG. 2 illustrates a typical webpage in the form of an HTML master document 40 and several imbedded objects 41-45 and text 46. The imbedded objects are typically graphic images, audio, video, or the like.

Thus when the client 20 enters the URL for the server 30 and the file name for a particular HTML master document 40 into the browser application 23, the client 20 and server 30 engage in communications which causes the base HTML document 40 and imbedded objects to be communicated to the client machine 20. In the present invention, at least the large imbedded object files, and preferably also the base HTML documents are hosted at a serving node that is in communication with the autonomous systems network 10 comprising the Internet. It will be understood that the present invention is not limited to HTTP requests on the World Wide Web, but its equally suitable for use with FTP requests and indeed any established communications protocol request across a network of networks. The most commonly used products are the IP protocols of IP, TCP, UDP, SMTP, POP3, HTTP, FTP, RTSP and MMS.

There are numerous Internet protocols which span the seven levers of the Open System Interconnection (OSI) reference model. Layers 1-7 in order are the Physical, Link, Network, Transport, Session, Presentation, and Application layers. Some of the more frequently utilized Internet protocols are FTP for file transfer, SMTP for e-mail, and TCP. However, the Internet Protocol (IP) is a network-layer (layer 3) protocol that contains addressing information and some control information in packets to be routed. IP has two primary responsibilities, those of providing connection links, best efforts delivery of packets or datagrams through a network, and providing fragmentation and reassembly of datagrams to support data links with different maximum-transmission unit sizes.

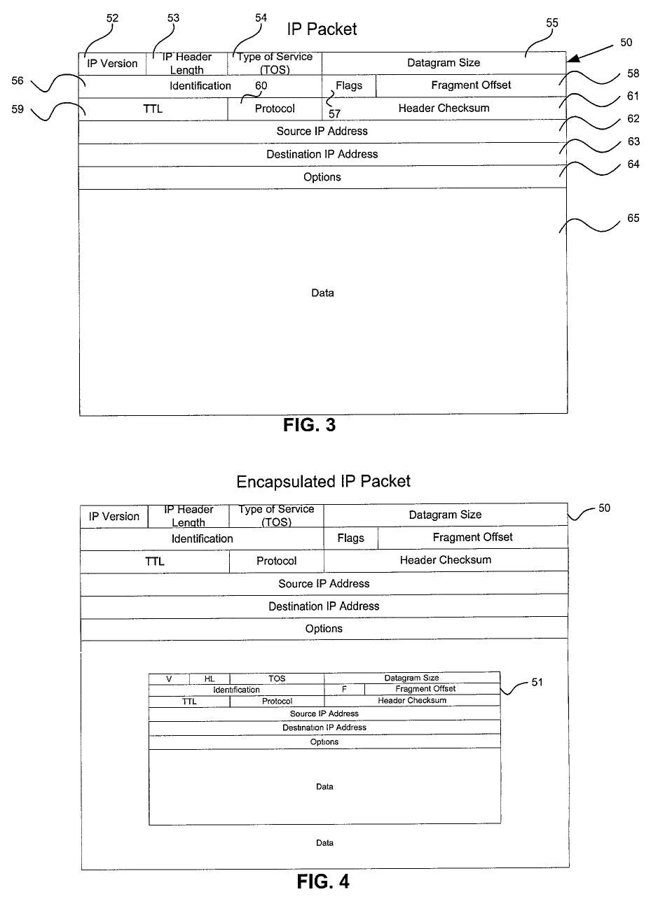

An IP packet or datagram contains several types of information as illustrated in FIG. 3. These include:

Version 52—indicates the version of IP currently used.

IP Header Length 53—indicates the datagram header length in 32-bit words.

Type-of-Service 54—specifies how an upper-layer protocol would like a current datagram to be handled, and assigns datagrams various levels of importance.

Total Length 55—specifies the length, in bytes, of the entire IP packet, including the data and header.

Identification 56—contains an integer that identifies the current datagram, used to help piece together datagram fragments.

Flags 57—consists of a 3-bit field of which the two low-order (least significant) bits control fragmentation.

Fragment Offset 58—indicates the position of the fragment's data relative to the beginning of the data in the original datagram, which allows the destination IP process to properly reconstruct the original datagram.

Time-to-Live 59—maintains a counter that gradually decrements down to zero, at which point the datagram is discarded to keep packets from looping endlessly.

Protocol 60—indicates which upper-layer protocol receives incoming packets after IP processing is complete.

Header Checksum 61—helps ensure IP header integrity.

Source Address 61—specifies the sending node.

Destination Address 63—specifies the receiving node.

Options 64—allows IP to support various options, such as security.

Data 65—contains upper-layer information.

FIG. 4 depicts a packet 51 encapsulated in IP packet 50. Even though the encapsulated packet 51 is depicted as an IP packet, for the purposes of the present invention, a proprietary packet configuration may also be utilized to better optimize the routing of data, such as tagging, encryption, and compression.

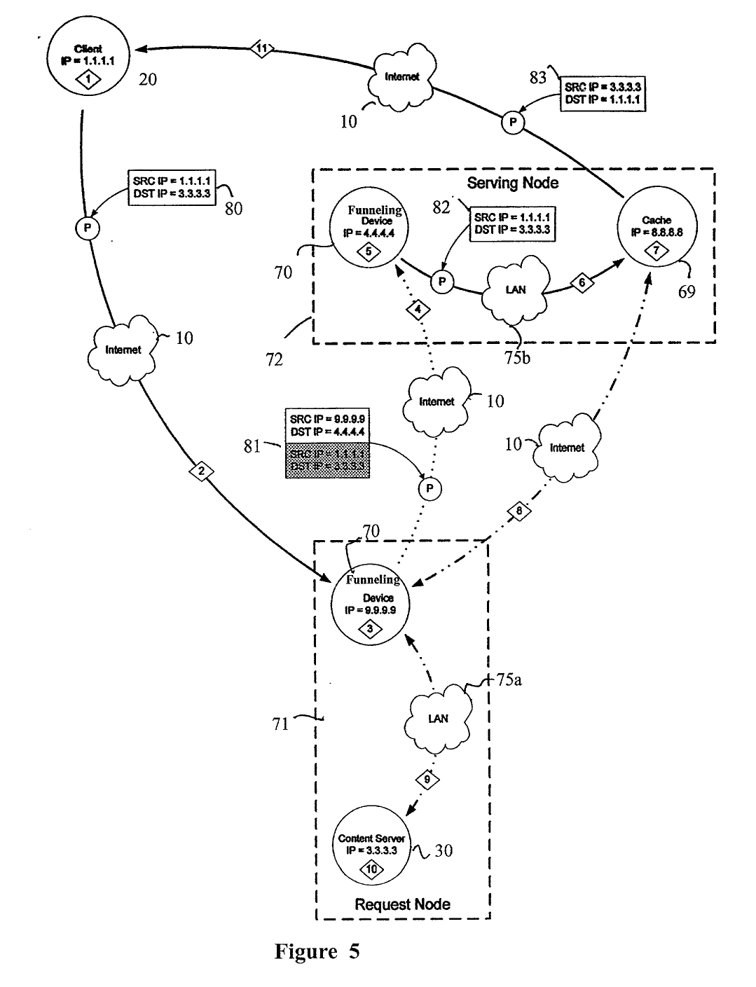

The operation of the general case of network optimization through uni-directional encapsulation is illustrated in FIG. 5. As shown, the client 20 enters a request for content located on server 30. The client's browser 23 generates a request for content in the form of packet 80 addressed to server 30. A funneling device 70 at the same node or point of presence with content server 30 scans incoming IP packets and intercepts requests directed to server 30. Funneling device 70, then in the generalized design where the serving node 72 is separate from the request node 71, encapsulates and transfers request packet 80 to another funneling device 70 at serving node 72 via packet encapsulation 81 which is again transmitted across the Internet 10. In a specialized case, the request could simply be forwarded across a local area or private network 75a so that the serving node 72 would be at the same point of presence as the receiving node 71.

The funneling device 70 of serving node 72 de-encapsulates the packet 81 and transfers via local network 75b in node 72 the request as packet 82 to a server, preferably optimally configured as cache 69 for serving data. Cache 69 receives the request for content located on server 30 and first checks to see if the requested content is stored locally. If content is not stored locally, cache 69 transmits a request for content via an IP packet to server 30 which passes through the Internet. The IP packet is coded to indicate to funneling device 70 at request node 71 not to intercept and process the request packet. Such processing by the funneling device 70 would create a looping situation. Upon receipt of the request packet from cache 69, content server 30 transmits the requested content to cache 69.

Once cache 69 has either determined the requested content is stored locally or has retrieved the requested content from server 30, this content is transmitted directly from cache 69 back to client 20. However, cache 69 encodes the IP packets directed to client 20 as if cache 69 were server 30 so that client 20 will continue to request and acknowledge receipt of content back to server 30. These request and acknowledgment packets will be intercepted by funneling device 70 at the request node and transmitted to the serving node 72 so that cache 69 is apprised of any missing packets that need to be resent.

In preferred embodiments, funneling device 70 will have its operating logic principally embedded in firmware to speed the processing of IP packets. Such an embedded device can be configured to deliver improved performance over alternative implementation of software operating in a router or server environment. In order to optimize network performance, funneling device 70 at the request node 71 may select from among several possible serving nodes based upon Internet proximity to the client and other predefined metrics of which it is aware including Internet weather or traffic congestion, and loads at the possible alternate serving nodes. The funneling device 70 at the serving node 72 may also select from among a plurality of cache or server devices depending upon the serving loads or traffic directed to those devices. Preferably the serving nodes 72 will monitor their selected metrics and communicate this information to the request node 71, where the metrics will be analyzed and maintained.

The encapsulation method utilized by funneling device 70 may be implemented either as a standard protocol such as GRE, NOSTUN, IPIP, and IPsec to provide some interoperability with other platforms, or is preferably implemented as a proprietary protocol offering additional functionality by tagging, encryption, and compression to improve flexibility, security and link performance. This implementation provides optimized serving of data, while eliminating the unnecessary overhead of two-way encapsulation commonly referred to as tunneling. Instead, only one way communication of encapsulated data is necessary, and the encapsulated data consists of little more than request packets which are of minimal size. Thus, the “funneling” of the present invention optimizes the delivery of data to the client with a minimum of additional overhead communication.

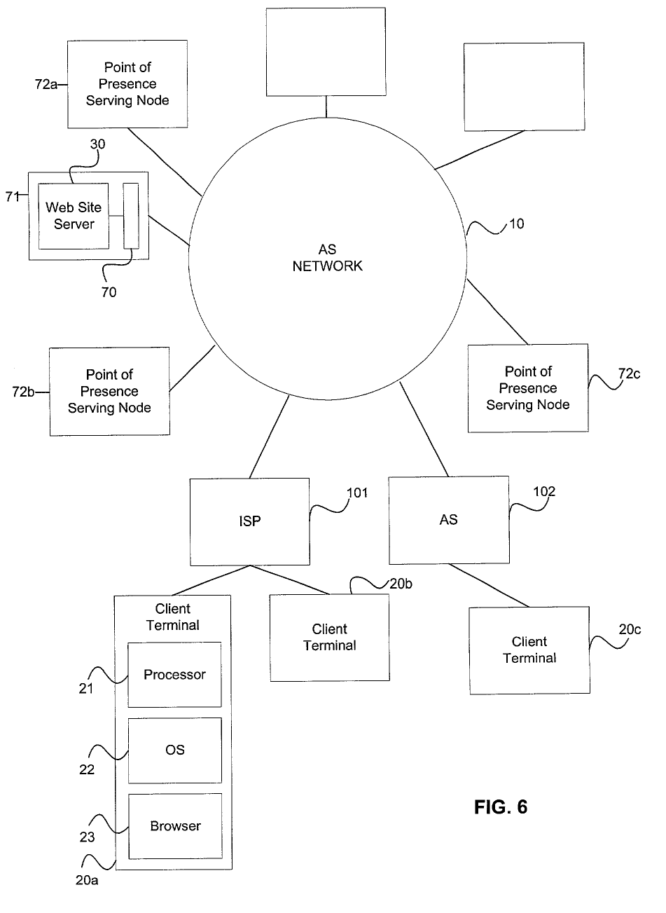

Operation of optimized serving can also be illustrated with reference to FIG. 6. Illustrated are several client terminals 20a, 20b, 20c, connected through AS 102 and another ISP AS 101 to the Internet 10. The Internet 10 is in communication with several serving nodes or points of presence 72a, 72b, 72c having funneling devices.

In operation, a client 20a sends a request to website server 30 at request node 71 for an HTML master document 40. The HTML document 40 and imbedded objects are then communicated to the client machine 20a as generally described in connection with FIG. 5 above. The imbedded objects may be large files containing audio, video or graphic information. These imbedded files may be hosted at any or all of the points of presence 72a, 72b, 72c. In the case of a request by client 20a for an HTML master document containing an imbedded object hosted at a serving node, the funneling device at the request node 71 would generally direct that the request for the master document and imbedded object be satisfied from serving point of presence 72a, which is in closest network proximity to the client 20a. Similarly, a request from client 20c would typically be satisfied by serving from point of presence 72c.

However, in the case of a request from client 20a when the cache or servers of point of presence 72a are experiencing high usage or otherwise indicating less than optimal status for fulfilling the request, the funneling device will preferably attempt to fulfill the request from another serving node that is able to serve the requested data optimally. In fulfilling the request, funneling device 70 has access to an analysis of cost metrics maintained at request node 70. Such metrics include available bandwidth, available servers or cache, serve or cache loads, network security, latency, jitter, packet loss, and bandwidth cost.

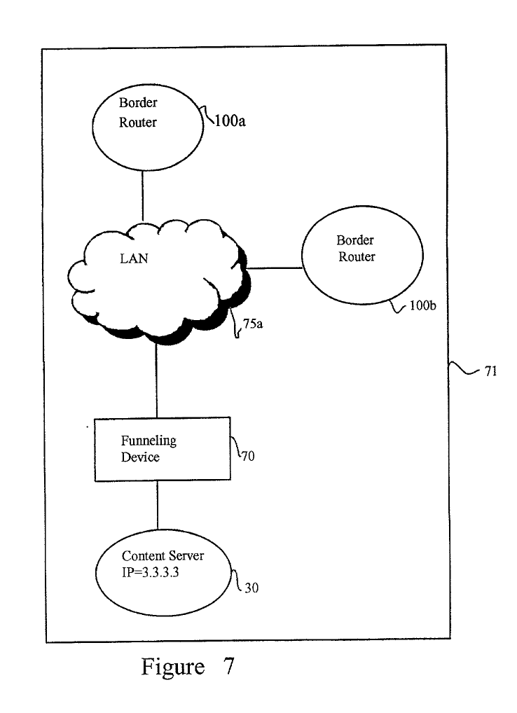

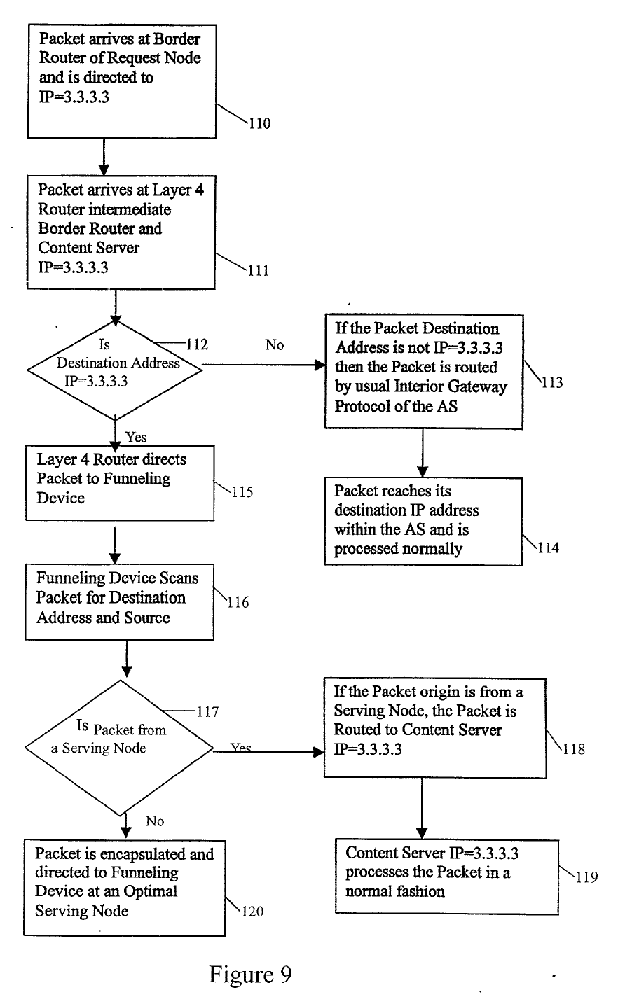

Details of processing of the client's request packet at the request node may be examined with respect to FIGS. 7-9. In one embodiment of the request node, incoming client request packets 80 are received by a border router 100. The border router 100 in turn directs the packet toward the destination IP address, hypothetically 3.3.3.3. However, a funneling device 70 according to the present invention sits immediate content server 30 having the desired IP address and any other router on the local area network 75a at request node 71. While funneling device 70 may have an IP address for configuration purposes, the internal routing protocols utilized by routers at request node 71 do not recognize funneling device 70 as a destination. To the routers in node 71, funneling device 76 appears as nothing other than a part of the cable to content server 30. When client request packet 80 or other packets directed to server 30 at IP address 3.3.3.3 pass along the cable, those packets are read by funneling device 70 and either encapsulated and redirected for serving requested data as explained above, or in the event the request is from a serving node 72, then the request is allowed to proceed to content server 30.

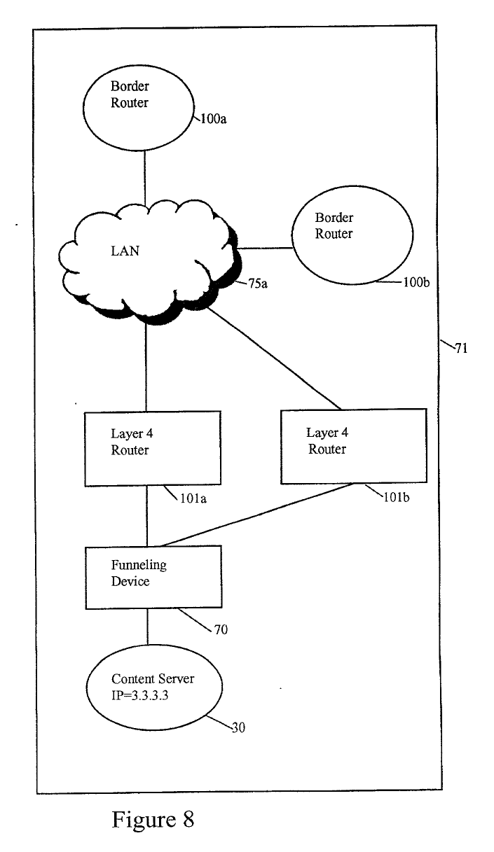

FIG. 8 illustrates an alternative request node 71 configured to provide funneling at OSI layer 4 rather than OSI layer 2 as described in connection with FIG. 7. Specifically, in FIG. 8, a client request packet 80 is received at the border router 100 and directed across the local area network 75a of the request node 71 toward content server 30 with IP address 3.3.3.3. However, intermediate every pathway that could lead to content server 30 is a layer 4 router which implements transparent redirection or policy routing based upon its processing of packets. With this method, one or more layer 4 routers 101 can intercept any packets directed for content server 30, allowing the packets to proceed to content server 30 if the requesting client is a serving node 72, cache 69 or server, but redirecting the packets to a funneling device 70 if the client is outside of the encapsulation request-seeking node system.

It should be noted that the funneling device 70 in the request node 71 not only selects the remote serving node for the associated client request to create a “virtual circuit” or “IP flow” between the client and remote serving node for the entire life of the session, but also utilizes an optimization protocol to select from among the possible serving nodes 72. The virtual circuit is defined by source and destination IP addresses, protocol type, and source and destination ports. This virtual circuit ensures that all requests and acknowledgment packets from the client during the session are routed appropriately.

Because the funneling device 70 in the request node addresses the encapsulated packets directly to corresponding funneling device 70 and serving node 72, there is no need for a special node design or utilization of border routers to intercept and redirect encapsulated packets. The critical operations at the serving node 72 are removing the encapsulation and directing the cache to serve the requested file as if it were coming from content server 30 to client 20.

Preferably, serving node 72 may utilize either layer 4 switching or policy based IP routing to communicate with transparent network cache 69. Transparency is the ability of a network cache to accept and respond to packets addressed to any server on the Internet. Both layer 4 switching and policy based IP routing techniques effectively have the funneling device 70 inspect the encapsulated packet, forward the packets addressed to server 30 at address 3.3.3.3 and other addresses of request node servers on a designated port, typically TCP port 80 to local network cache 69, rather than in the direction of server 30.

Transparency utilizing policy based routing does not generally provide the same level of monitoring capability of cache load and performance, but may be implemented in several ways. For example, Cache Flow, Inc. typically forwards all traffic directed for TCP port 80 to cache devices attached on Ethernet interface for service. Cisco Systems, Inc. uses access lists in combination with route maps to selectively forward packets to attached cache devices for service. Bay Networks routers rely upon traffic filters to forward packets to a network cache device 69 as the next hop. Any of these techniques are suitable for use in serving node 72.

In an optimum configuration, at least some serving nodes will also function as secondary, or tertiary, request nodes. In this fashion, if an encapsulated request packet arrives at serving node 72, and serving node 72 is not operating within the established network health and performance thresholds, serving node 72 may act as a request node 71 and forwards re-encapsulated packet on to a secondary serving node. In turn, that secondary serving node may act as a tertiary request node and in appropriate circumstances forward the packet on to a tertiary serving node, thus defining a hierarchy of request and serving nodes.

While the invention has been described in terms of its preferred embodiments, numerous alterations of the methods herein described will suggest themselves to those skilled in the art. It will be understood that the details and arrangements of the embodiments that have been described and illustrated in order to explain the nature of the invention are not to be construed as any limitation of the invention, and all such alterations which do not depart from the spirit of invention are intended to be included within the scope of the appended claims.

What is claimed is:

1. A method of identifying an optimum network node within a network of autonomous systems for delivery of data to a destination comprising steps of:
(a) establishing network performance and health thresholds based upon at least one of network bandwidth, available servers, server load, network security, latency, jitter, packet loss and bandwidth cost metrics at a request node;
(b) the request node monitors has at least one metrics or plurality of serving nodes;
(c) the request node metrics receiving a request for data and determining the optimum serving node for delivery of requested data based on said at least one metrics;
(d) the dispatch node receiving the request encapsulates and transfers the request to the optimum serving node; and
(e) the optimum serving node transparently delivers the requested data.

2. The method of claim 1 wherein the dispatch node and the optimum serving are the same node.

3. The method of claim 1 wherein the optimum serving node is also a secondary dispatch node communicating with a plurality of serving nodes.

4. The method of claim 3 wherein the secondary dispatch node and one of the plurality of serving node are the same node.

5. The method of claim 3 wherein at least one of the plurality of serving nodes is a tertiary dispatch node communicating with a plurality of serving nodes.

6. The method of claim 5 wherein the tertiary dispatch node and one of the plurality serving node are the same node.

7. The method of claim 1, wherein a serving node determines its cost metrics and communicates its metrics to the dispatch node.

8. The method of claim 1 wherein the dispatch node stores cost metrics for all serving nodes communicating with the dispatch node.

9. The method of claim 1, wherein the communications network is characterized by one or more established communications protocols, and wherein the method is performed without modification of the established communications protocols.

10. The method of claim 9, wherein the established communications protocols include at least one of the IP-based protocols selected from IP, TCP, UDP, SMTP, POP3, HTTP, FTP, RTSP and MMS.

11. The method of claim 1 wherein the network has a static topology.

12. The method of claim 1 wherein the network has a dynamic topology.

13. The method of claim 1 wherein the dispatch node utilizes an embedded device to encapsulate the request.

14. The method of claim 1 wherein the serving node utilizes an embedded device to process the encapsulated request.

15. A network apparatus for identifying an optimum network node within a network of autonomous systems for delivery of data to a destination having a means for:
(a) establishing network performance and health thresholds based upon at least one metric communicated from a plurality of serving nodes;
(b) a means for receiving requests for data; a means for determining the optimum serving node for delivery of requested data based upon said at least one metric;
(c) a means for encapsulating the request and addressing the request to the optimum serving node.

16. The apparatus of claim 15 wherein the means for encapsulating the request is an embedded device.

17. The apparatus of claim 15 wherein the means for receiving requests is adapted to receive requests formatted in an established communication protocol.

18. The apparatus of claim 15 wherein the means for addressing the request to the optimum serving node utilizes an established communication protocol.

19. The apparatus of claim 17 wherein the established communication protocol is selected from the group of IP-based protocols.

20. The apparatus of claim 18 wherein the established communication protocol is an IP-based protocol selected from the group of IP, TCP, UDP, SMTP, POP3, HTTP, FTP, RTSP and MMS.
